(19) United States
(12) Patent Application Publication
(10) Pub. No.: US 2025/0248788 A1
(43) Pub. Date: Aug. 7, 2025

(54) SCULPTING AND SHAPING TOOLS FOR DENTAL RESIN

(71) Applicant: AIR FORCE MEDICAL UNIVERSITY, Xi'an (CN)

(72) Inventors: Jihua CHEN, Xi'an (CN); Lina NIU, Xi'an (CN); Fu WANG, Xi'an (CN); Ling ZHANG, Xi'an (CN); Wei ZHOU, Xi'an (CN); Shiqi DAI, Xi'an (CN); Kai TANG, Xi'an (CN)

(73) Assignee: AIR FORCE MEDICAL UNIVERSITY, Xi'an (CN)

(21) Appl. No.: 19/037,347

(22) Filed: Jan. 27, 2025

(30) Foreign Application Priority Data
Feb. 2, 2024 (CN) 202420269861.9

(51) Int. Cl. A61C 5/60; A61C 3/02; A61C 3/08

(52) U.S. Cl. CPC A61C 5/60; A61C 3/02; A61C 3/08

(57) ABSTRACT

Embodiments of the present disclosure provide a sculpting and shaping tool for dental resin, comprising: a handle, a rotating assembly, and a sculpting and shaping tip. One end of the sculpting and shaping tip is coaxially and rotatably connected to one end of the handle through the rotating assembly. When in use, after a resin restorative material is filled in a carious cavity, the sculpting and shaping tip is placed on the resin restorative material. The handle moves to drive the sculpting and shaping tip to rotate, thereby rolling a surface of the resin restorative material. After rolling, the surface of the resin restorative material is smoother and free of protrusions, effectively preventing unevenness on the surface.

### CROSS REFERENCE TO RELATED APPLICATIONS

This application claims priority to Chinese Patent Application No. 202420269861.9, filed on Feb. 2, 2024, the entire contents of which are incorporated herein by reference.

### TECHNICAL FIELD

The present disclosure relates to the field of dental medical devices, and in particular, to a sculpting and shaping tool for dental resin.

### BACKGROUND

Dental caries is an ailment characterized by the erosion and softening of tooth structure, leading to discoloration before developing into hard tissue defects in teeth that form cavities. The standard treatment for dental caries involves filling these cavities with restorative materials, predominantly using resin restorative materials. This process typically includes cleaning out the cavity, applying the resin restorative material, shaping the resin restorative material with a resin sculpting and shaping knife, and then curing (hardening) the material.

Conventional resin sculpting and shaping knives generally only have a flat blade. When the flat blade is used to shape the material, it is insufficient for creating an even surface across the entire resin restorative material, which often results in localized bumps or unevenness. The surface of the resin restorative material is difficult to be flat and smooth, and subsequent grinding and polishing procedures must be relied upon to make the restoration formed by the resin restorative material meet a smooth texture requirement. This process will take a lot of operation time, affecting the restorative efficiency

Therefore, there is a need to provide a sculpting and shaping tool for dental resin that solves the problem of unevenness of the surface of resin restorative material.

### SUMMARY

One or more embodiments of the present disclosure provide a sculpting and shaping tool for dental resin, comprising: a handle, a rotating assembly, and a sculpting and shaping tip. One end of the sculpting and shaping tip is coaxially and rotatably connected to one end of the handle through the rotating assembly.

In some embodiments, the sculpting and shaping tip is in a shape of a cone, and a bottom surface of the cone is opposite to the handle.

In some embodiments, a length of the cone is in a range of 3 mm to 10 mm, and a diameter of the bottom surface the cone is in a range of 1 mm to 2 mm.

In some embodiments, the sculpting and shaping tip is in a shape of a cylinder.

In some embodiments, a length of the cylinder is in a range of 3 mm to 10 mm, and a diameter of the cylinder is in a range of 1 mm to 2 mm.

In some embodiments, a shape of the sculpting and shaping tip is a semi-ellipsoid, and a bottom surface of the semi-ellipsoid is opposite to the handle.

In some embodiments, a length of a minor axis of the semi-ellipsoid is in a range of 0.5 mm to 2 mm, and a length of a major axis of the semi-ellipsoid is in a range of 2 mm to 5 mm.

In some embodiments, the rotating assembly includes a rotating shaft, a plurality of rollers, and a rotating shaft sleeve. The plurality of rollers are coaxially sleeved onto the rotating shaft. A rotating shaft extension hole is arranged on an end surface of one end of the rotating shaft sleeve, and the rotating shaft is coaxially arranged in the rotating shaft sleeve. One end of the rotating shaft extends through the rotating shaft extension hole on the rotating shaft sleeve and is fixedly connected to the one end of the sculpting and shaping tip, and another end of the rotating shaft sleeve is fixedly connected to the one end of the handle.

In some embodiments, the plurality of rollers includes a least two rollers.

In some embodiments, the plurality of rollers are arranged in the rotating shaft sleeve, and a diameter of each of the plurality of rollers matches an inner diameter of the rotating shaft sleeve.

In some embodiments, another end of the rotating shaft sleeve is provided with an internal thread, the one end of the handle is provided with an external thread, and another end of the rotating shaft sleeve is connected to the one end of the handle by threads.

In some embodiments, one end of the handle is arranged perpendicular another end of the handle.

In some embodiments, a cutter tip is disposed on another end of the handle.

In some embodiments, the sculpting and shaping tool for dental resin further comprises two cap covers. The two cap covers are detachably arranged at two ends of the handle, respectively.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, where:

FIG. 1 is a schematic diagram illustrating a sculpting and shaping knife for resin according to the prior art;

FIG. 2 is a schematic diagram illustrating a sculpting and shaping tool for dental resin with a conical sculpting and shaping tip according to some embodiments of the present disclosure;

FIG. 3 is a schematic diagram illustrating a sculpting and shaping tool for dental resin with a cylindrical sculpting and shaping tip according to some embodiments of the present disclosure;

FIG. 4 is a schematic diagram illustrating a sculpting and shaping tool for dental resin with a semi-ellipsoid sculpting and shaping tip according to some embodiments of the present disclosure;

FIG. 5 is a schematic diagram illustrating a handle in a bent structure according to some embodiments of the present disclosure.

FIG. 6 is a schematic diagram illustrating a sculpting and shaping tool for dental resin with a cutter tip according to some embodiments of the present disclosure.

FIG. 7 is a schematic diagram illustrating a sculpting and shaping tool for dental resin with a handle in a bent structure and a cutter tip according to some embodiments of the present disclosure; and

FIG. 8 is a schematic diagram illustrating a sculpting and shaping tool for dental resin with cap covers according to some embodiments of the present disclosure.

Markings in the figures denote: 1, handle; 2, connection rod; 3, sculpting and shaping tip; 4, roller; 5, rotating shaft; 6, rotating shaft sleeve; 7, cutter tip; 8, cap cover.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and a person of ordinary skill in the art can apply the present disclosure to other similar scenarios in accordance with these drawings without creative labor. Unless obviously obtained from the context or the context illustrates otherwise, the same numeral in the drawings refers to the same structure or operation.

It should be noted that the terms “first”, “second”, etc., in the specification and claims of the present disclosure and the accompanying drawings described above are used to distinguish similar objects and need not be used to describe a particular order or sequence. It should be understood that the data so used may be interchangeable, where appropriate, so that the embodiments of the present invention described herein can be practiced in an order other than those illustrated or described herein. Additionally, the terms “comprising” and “having”, and any variations thereof, are intended to cover non-exclusive embodiments.

As shown in the present disclosure and in the claims, unless the context clearly suggests an exception, the words “a”, “an”, “one” and/or “the” are not singular, but may also include the plural. Generally, the terms “including” and “comprising” suggest only the inclusion of clearly identified steps and elements that do not constitute an exclusive list, and the method or apparatus may also include other steps or elements.

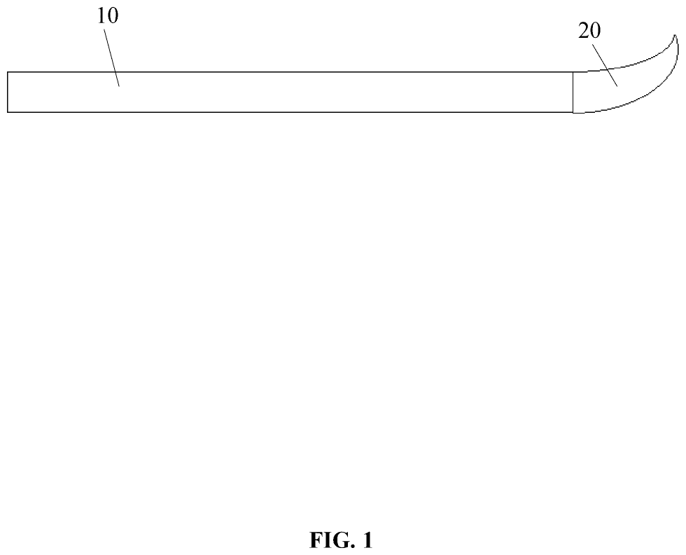

FIG. 1 is a schematic diagram illustrating a sculpting and shaping tool for resin according to the prior art. As shown in FIG. 1, the sculpting and shaping tool for resin includes a knife handle 10 and a flat blade 20 arranged at an end of the knife handle 10. The flat blade 20 may be configured to extrude and organize a resin restorative material after a carious cavity is filled with resin and to shape the resin restorative material to form a restoration. However, it is difficult to solve the problem of the resin restorative material being susceptible to localized bumps or unevenness only using a flat blade. In view of the foregoing, some embodiments of the present disclosure provide a novel sculpting and shaping tool for dental resin.

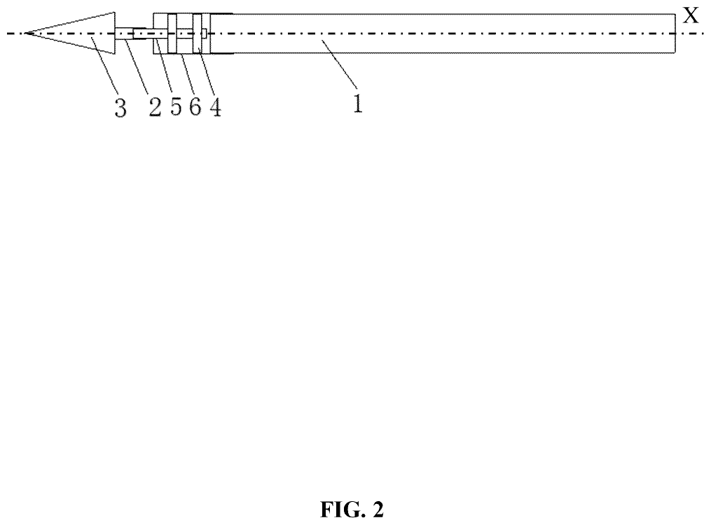

FIG. 2 is a schematic diagram illustrating a sculpting and shaping tool for dental resin with a conical sculpting and shaping tip according to some embodiments of the present disclosure. Referring to FIG. 2, the sculpting and shaping tool for dental resin includes: a handle 1, a rotating assembly, and a sculpting and shaping tip 3. One end of the sculpting and shaping tip 3 may be coaxially rotationally connected to one end of the handle 1 through the rotating assembly.

The handle 1 is a gripping portion of the sculpting and shaping tool for dental resin.

In some embodiments, a material of the handle 1 includes, but is not limited to, one or a combination of stainless steel, aluminum alloy, engineering plastic, silicone, or the like.

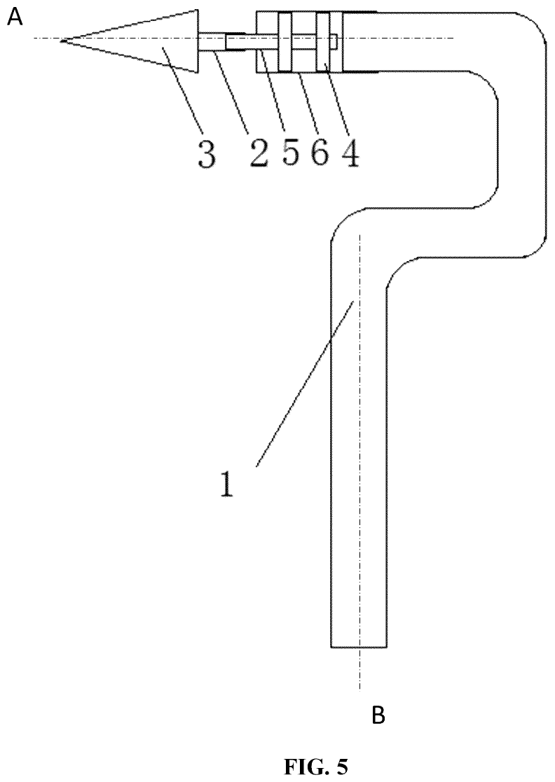

In some embodiments, the handle 1 includes a variety of shapes. For example, the handle 1 is a straight handle or an arc-shaped handle. The handle 1 may also be bent and rotated based on an actual application scenario, forming a bent structure with a corner. More content about the handle 1 can be found in FIG. 5 and the related descriptions thereof.

In some embodiments, a cross-section of the handle 1 is circular, oval, or rectangular. Sizes and shapes of cross-sections at different locations of the handle 1 may be the same or different.

In some embodiments, a surface of the handle 1 has an anti-slip texture to facilitate the grip of a user. The surface of the handle 1 may be coated with an anti-slip material such as rubber or silicone.

In some embodiments, the surface of the handle 1 has depressions and bumps that conform to a shape of the user's hand to form an ergonomic handle.

The rotating assembly is a connection device configured to connect the sculpting and shaping tip 3 and the handle 1. The rotating assembly may include, but not limited to, a slide bearing, a swivel joint, or the like.

In some embodiments, one end of the rotating assembly is fixedly connected to the sculpting and shaping tip 3 (e.g., through a threaded connection, a snap connection, or a pin connection), and another end of the rotating assembly is coaxially and rotatably connected to the handle. In some other embodiments, the end of the rotating assembly is coaxially and rotatably connected to the sculpting and shaping tip 3, and the end of the rotating assembly is fixedly connected to the handle.

In some embodiments, a rotating axis of the rotating assembly is located on a same straight line X as a center axis of the handle 1.

In some embodiments, the rotating assembly includes a rotating shaft, a plurality of rollers, and a rotating shaft sleeve. More content about the rotating assembly can be referred to the related descriptions below.

The sculpting and shaping tip 3 is a device configured to adjust a shape of a resin restorative material.

In some embodiments, the material of the sculpting and shaping tip 3 includes, but is not limited to, one or a combination of metal, nylon, PTFE, or the like.

In some embodiments, the sculpting and shaping tip 3 includes a variety of shapes and sizes. More content about the shapes and sizes of the sculpting and shaping tip 3 can be referred to the related descriptions below.

In some embodiments of the present disclosure, by connecting the sculpting and shaping tip and the handle through the rotating assembly, when the rotating assembly is driven by the handle to rotate, the sculpting and shaping tip is driven to synchronously rotate, thereby rolling a surface of the resin restorative material that fills in a carious cavity. After rolling, the surface of the resin restorative material is smoother and free of protrusions, thus preventing unevenness on the surface of the resin restorative material.

In some embodiments, as shown in FIG. 2, the sculpting and shaping tip 3 is in a shape of a cone, with a bottom surface of the cone opposite to the handle 1.

In some embodiments of the present disclosure, setting a conical sculpting and shaping tip is suitable for fine rolling and shaping of the resin restorative material.

In some embodiments, when the sculpting and shaping tip 3 is in the shape of the cone, a length of the cone is in a range of 3 mm to 10 mm and a diameter of the bottom surface of the cone is in a range of 1 mm to 2 mm.

In some embodiments, the length of the cone may further be in at least one of a range of 3 mm to 5 mm, a range of 3 mm to 8 mm, a range of 4 mm to 6 mm, a range of 4 mm to 9 mm, a range of 5 mm to 7 mm, a range of 5 mm to 9 mm, a range of 6 mm to 8 mm, a range of 6 mm to 10 mm, a range of 7 mm to 10 mm, etc. In some embodiments, the diameter of the bottom surface of the cone may further be in at least one of a range of 1 mm to 1.2 mm, a range of 1.2 mm to 1.4 mm, a range of 1.4 mm to 1.6 mm, a range of 1.6 mm to 1.8 mm, a range of 1.8 mm to 2 mm, a range of 1 mm to 1.4 mm, a range of 1.2 mm to 1.6 mm, a range of 1.4 mm to 1.8 mm, a range of 1.6 mm to 2 mm, etc.

In some embodiments, the length of the cone may further be at least one of 3 mm, 4 mm, 5 mm, 6 mm, 7 mm, 8 mm, 9 mm, 10 mm, etc. In some embodiments, the diameter of the bottom surface of the cone may further be at least one of 1 mm, 1.2 mm, 1.4 mm, 1.6 mm, 1.8 mm, 2 mm, etc.

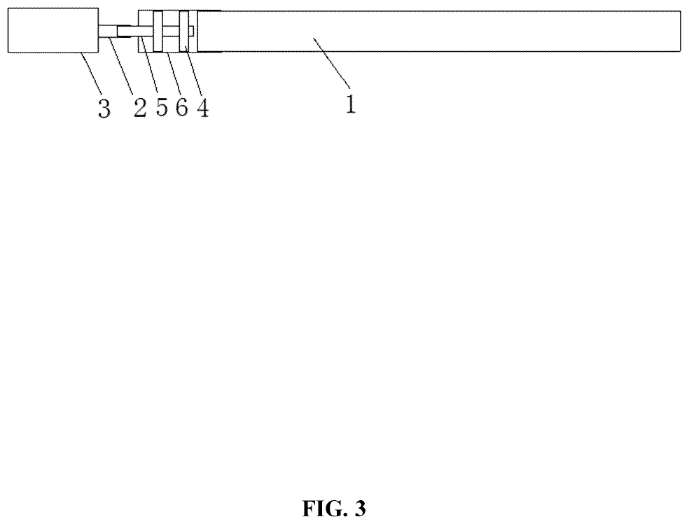

FIG. 3 is a schematic diagram illustrating a sculpting and shaping tool for dental resin with a cylindrical sculpting and shaping tip according to some embodiments of the present disclosure. In some embodiments, as shown in FIG. 3, the sculpting and shaping tip 3 is in a shape of a cylinder.

In some embodiments of the present disclosure, setting a cylindrical sculpting and shaping tip is suitable to flat roll the resin restorative material over a large area to obtain a flat surface.

In some embodiments, when the sculpting and shaping tip 3 is in the shape of the cylinder, a length of the cylinder is in a range of 3 mm to 10 mm and a diameter of the cylinder is in a range of 1 mm to 2 mm.

In some embodiments, the length of the cylinder may further be in at least one of a range of 3 mm to 5 mm, a range of 3 mm to 8 mm, a range of 4 mm to 6 mm, a range of 4 mm to 9 mm, a range of 5 mm to 7 mm, a range of 5 mm to 9 mm, a range of 6 mm to 8 mm, a range of 6 mm to 10 mm, a range of 7 mm to 10 mm, etc. In some embodiments, the diameter of the cylinder may further be in at least one of a range of 1 mm to 1.2 mm, a range of 1.2 mm to 1.4 mm, a range of 1.4 mm to 1.6 mm, a range of 1.6 mm to 1.8 mm, a range of 1.8 mm to 2 mm, a range of 1 mm to 1.4 mm, a range of 1.2 mm to 1.6 mm, a range of 1.4 mm to 1.8 mm, a range of 1.6 mm to 2 mm, etc.

In some embodiments, the length of the cylinder may further be at least one of 3 mm, 4 mm, 5 mm, 6 mm, 7 mm, 8 mm, 9 mm, 10 mm, etc. In some embodiments, the diameter of the cylinder may further be 1 mm, 1.2 mm, 1.4 mm, 1.6 mm, 1.8 mm, 2 mm, etc.

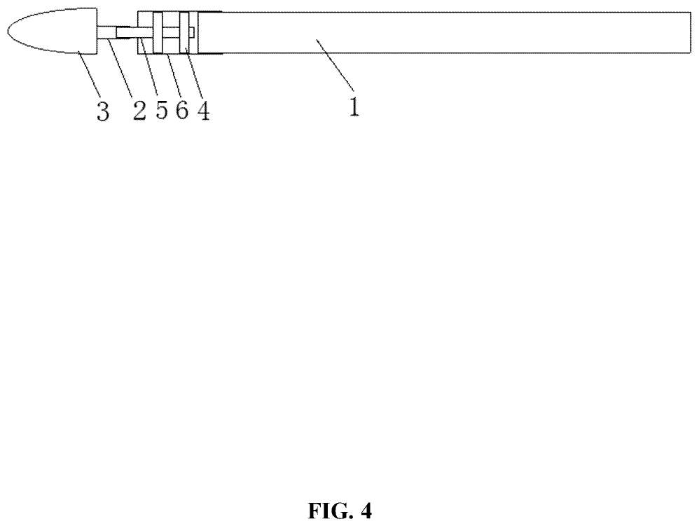

FIG. 4 is a schematic diagram illustrating a sculpting and shaping tool for dental resin with a semi-ellipsoid sculpting and shaping tip according to some embodiments of the present disclosure. In some embodiments, as shown in FIG. 4, the sculpting and shaping tip 3 is in a shape of a semi-ellipsoid, with a bottom surface of the semi-ellipsoid opposite to the handle 1.

In some embodiments of the present disclosure, setting the semi-ellipsoid sculpting and shaping tip is suitable for rolling the resin restorative material into a curved surface, thereby achieving a surface with a smooth curved structure.

In some embodiments, when the sculpting and shaping tip 3 is in the shape of the semi-ellipsoid, a length of a minor axis of the semi-ellipsoid is in a range of 0.5 mm to 2 mm, and a length of a major axis of the semi-ellipsoid is in a range of 2 mm to 5 mm.

In some embodiments, the length of the minor axis of the semi-ellipsoid may further be in at least one of a range of 0.5 mm to 0.75 mm, a range of 0.75 mm to 1.0 mm, a range of 1.0 mm to 1.25 mm, a range of 1.25 mm to 1.5 mm, a range of 1.5 mm to 1.75 mm, a range of 1.75 mm to 2.0 mm, etc. The length of the major axis of the semi-ellipsoid may further be in at least one of a range of 2.0 mm to 2.5 mm, a range of 2.5 mm to 3.0 mm, a range of 3.0 mm to 3.5 mm, a range of 3.5 mm to 4.0 mm, a range of 4.0 mm to 4.5 mm, a range of 4.5 mm to 5.0 mm, etc.

In some embodiments, the length of the minor axis of the semi-ellipsoid may further be at least one of 0.5 mm, 0.75 mm, 1.0 mm, 1.25 mm, 1.5 mm, 1.75 mm, 2.0 mm, etc. In some embodiments, the length of the major axis of the semi-ellipsoid length may further be at least one of 2.0 mm, 2.5 mm, 3.0 mm, 3.5 mm, 4.0 mm, 4.5 mm, 5.0 mm, etc.

It is to be understood that the shape of the sculpting and shaping tip may include, but not limited to, the three shapes described above, and the sculpting and shaping tip 3 may be of other suitable shapes, such as a sphere, a hemisphere, an ellipsoid, or the like. A specific shape and size of the sculpting and shaping tip may be determined based on actual application scenarios and needs.

In some embodiments of the present disclosure, by setting the sculpting and shaping tip with various shapes and sizes, an operator can change different sculpting and shaping tips according to actual needs, which is conducive to enhancing the scope of applicability of the sculpting and shaping tool for dental resin.

In some embodiments, as shown in FIG. 2, a rotating assembly includes a rotating shaft 5, a plurality of rollers 4, and a rotating shaft sleeve 6. The rollers 4 may be coaxially fixedly sleeved onto the rotating shaft 5. A rotating shaft extension hole may be arranged on an end surface of one end of the rotating shaft sleeve 6. The rotating shaft 5 may be coaxially arranged in the rotating shaft sleeve 6. One end of the rotating shaft 5 may extend through the rotating shaft extension hole on the rotating shaft sleeve 6 and may be fixedly connected with one end of the sculpting and shaping tip 3, and another end of the rotating shaft sleeve 6 may be fixedly connected with one end of the handle 1.

The rotating shaft 5 is a rotating shaft configured to connect the sculpting and shaping tip 3 and the rollers 4. The rotating shaft 5 may be connected to the sculpting and shaping tip 3 in a variety of ways, such as a threaded connection, a snap connection, a pin connection, or the like.

The roller 4 is a rotating device configured to realize a coaxial rotation connection.

The rotating shaft sleeve 6 is a sleeve configured to accommodate the rollers 4 and a portion of the rotating shaft 5.

In some embodiments, of the plurality of rollers 4 include at least two rollers, and the at least two rollers 4 are coaxially fixedly sleeved onto the rotating shaft 5.

In some embodiments, the rotating shaft extension hole is arranged on the end surface of one end of the rotating shaft sleeve 6, and the rotating shaft 5 is coaxially arranged in the rotating shaft sleeve 6. One end of the rotating shaft 5 may extend through the rotating shaft extension hole on the rotating shaft sleeve 6 and may be fixedly connected with one end of the sculpting and shaping tip 3 by threads.

In some embodiments, the rollers 4 are arranged within the rotating shaft sleeve 6. A diameter of each of the rollers 4 may match with an inner diameter of the rotating shaft sleeve 6.

In some embodiments, another end of the rotating shaft sleeve 6 is arranged with an internal thread, one end of the handle 1 is arranged with an external thread, the internal thread matches the external thread, and another end of the rotating shaft sleeve 6 is threadedly connected to the end of the handle 1.

In some embodiments, a connection rod 2 is coaxially arranged on an end surface of one end of the sculpting and shaping tip 3. One end of the rotating shaft 5 may extend through the rotating shaft extension hole on the rotating shaft sleeve 6 and may be fixedly connected to an end portion of the connection rod 2 by threads.

In some embodiments, the handle 1 is set to be a non-straight handle based on actual application scenarios and needs. For example, the handle 1 is a bent structure with a corner. In some embodiments, one end of the handle 1 is set perpendicular to another end of the handle 1.

FIG. 5 is a schematic diagram illustrating a handle in a bent structure according to some embodiments of the present disclosure. As shown in FIG. 5, one end of the handle 1 is set perpendicular to another end of the handle 1, i.e., an extension line A of one end of the handle 1 is perpendicular to an extension line B of another end.

In some embodiments, the handle 1 has a plurality of corners. One end of the handle 1 may be connected to another end of the handle 1 by a transition segment, with one end of the handle 1 being set perpendicular to another end of the handle 1.

In some embodiments of the present disclosure, by adopting a handle with a bent structure, the sculpting and shaping tool for dental resin is made more convenient to operate in space-limited environments, thereby extending the scope of application of the sculpting and shaping tool for dental resin, and making it more convenient for an operator to use, henceforth enhancing the overall user experience.

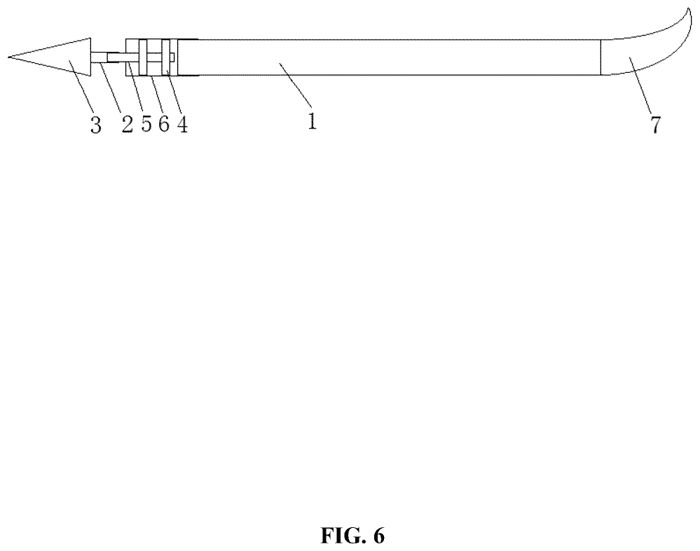

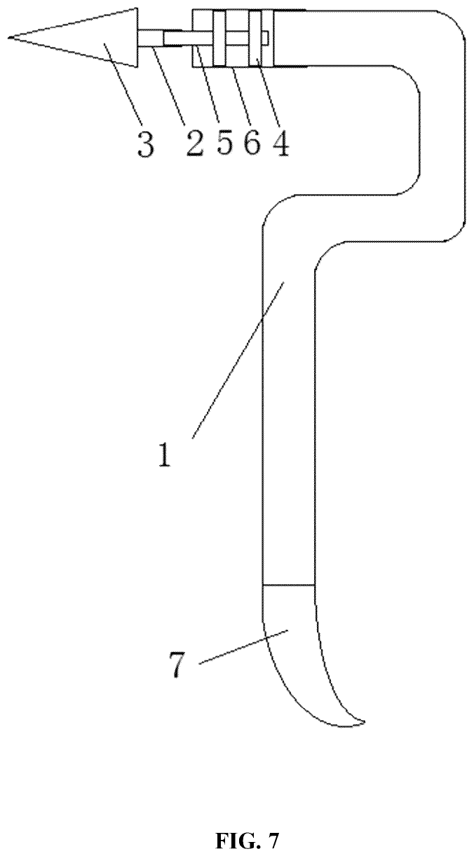

FIG. 6 is a schematic diagram illustrating a sculpting and shaping tool for dental resin with a cutter tip according to some embodiments of the present disclosure. FIG. 7 is a schematic diagram illustrating a sculpting and shaping tool for dental resin with a handle in a bent structure and a cutter tip according to some embodiments of the present disclosure.

In some embodiments, as shown in FIG. 6 and FIG. 7, a cutter tip 7 is arranged at another end of the handle 1.

The cutter tip 7 is a device configured to sculpt and shape a resin restorative material. The cutter tip 7 may include, but not limited to, a straight cutter, a curved cutter, a hook cutter, or the like. A specific shape and size of the cutter tip 7 may be determined according to the actual application scenarios and needs.

In some embodiments of the present disclosure, the sculpting and shaping tool for dental resin is made multi-functional by arranging the cutter tip at another end of the handle, allowing it to both roll the resin restorative material with the sculpting and shaping tip and perform sculpting with the cutter tip.

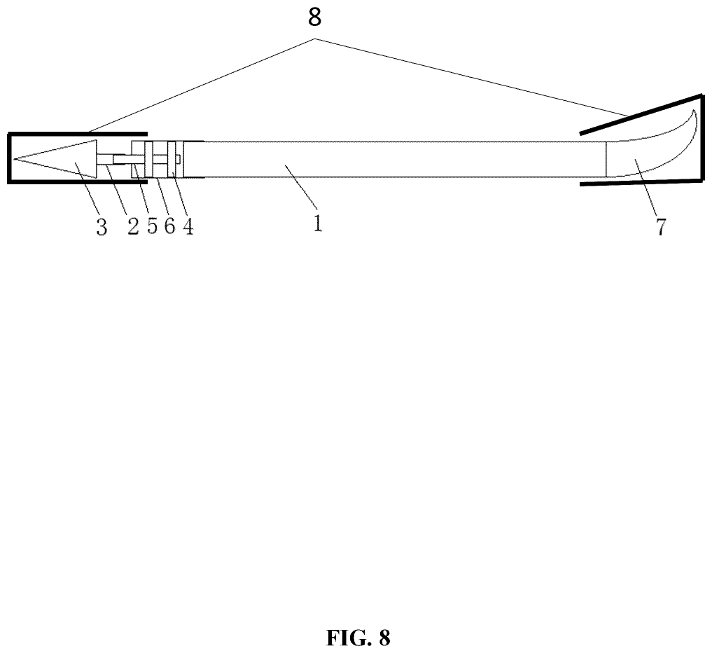

FIG. 8 is a schematic diagram illustrating a sculpting and shaping tool for dental resin with cap covers according to some embodiments of the present disclosure.

In some embodiments, as shown in FIG. 8, the sculpting and shaping tool for dental resin may further include cap covers 8. The cap covers 8 may be detachably arranged at two ends of the handle 1, respectively. The cap cover 8 may be configured to accommodate the sculpting and shaping tip 3 and the cutter tip 7. In some embodiments, each of the cap covers 8 is connected to each of two ends of the handle 1 by a snap-fit connection, a threaded connection, or the like. When the sculpting and shaping tool is not in use, the cap cover 8 may protect both the sculpting and shaping tip 3 and the cutter tip 7.

A usage manner of the sculpting and shaping tool for dental resin of the present disclosure is as follows: after the resin restorative material is filled into a carious cavity, the handle 1 is held and moved back and forth, thus driving the sculpting and shaping tip 3 to shape the resin restorative material by rolling back and forth on a surface of the resin restorative material. Further, when it is necessary to sculpt the resin restorative material, the cutter tip 7 at another end of the handle is used for sculpting.

In the sculpting and shaping tool for dental resin described in the present disclosure, the sculpting and shaping tip is coaxially and rotatably connected with the handle through the rotating assembly. When in use, after the resin restorative material is filled into the carious cavity, the sculpting and shaping tip is placed on the resin restorative material, and the handle is moved to drive the sculpting and shaping tip to rotate, so as to roll the surface of the resin restorative material. After rolling, the surface of the resin restorative material is smoother without protrusions, preventing unevenness on the surface of the resin restorative material.

The basic concepts have been described above, and it is apparent to those skilled in the art that the foregoing detailed disclosure is intended as an example only and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure. Such as “an embodiment”, “one embodiment”, and/or “some embodiments” means a feature, structure, or characteristic associated with at least one embodiment of the present disclosure. Accordingly, it should be emphasized and noted that “an embodiment” or “one embodiment”, or “an alternative embodiment” referred to two or more times in different places in the present disclosure do not necessarily refer to the same embodiment. In addition, certain features, structures, or characteristics in one or more embodiments of the present disclosure may be suitably combined.

Similarly, it should be noted that in order to simplify the presentation of the present disclosure, and thereby aid in the understanding of one or more embodiments of the invention, the foregoing descriptions of embodiments of the present disclosure sometimes combine a variety of features into a single embodiment, accompanying drawings, or descriptions thereof. However, this method of disclosure does not imply that more features are required for the objects of the present disclosure than are mentioned in the claims. Rather, claimed subject matter may lie in less than all features of a single foregoing disclosed embodiment.

Some embodiments use numbers to describe the number of components, attributes, and it should be understood that such numbers used in the description of embodiments are modified in some examples by the modifiers “approximately”, “nearly”, or “substantially”. Unless otherwise noted, the terms “approximately”, “nearly”, or “substantially” indicates that a ±20% variation in the stated number is allowed. Correspondingly, in some embodiments, the numerical parameters used in the present disclosure and claims are approximations, which can change depending on the desired characteristics of individual embodiments. In some embodiments, the numerical parameters should consider the specified number of valid digits and employ general place-keeping. While the numerical domains and parameters used to confirm the breadth of their ranges in some embodiments of the present disclosure are approximations, in specific embodiments, such values are set to be as precise as practicable.

For each of the patents, patent applications, patent application disclosures, and other materials cited in the present disclosure, such as articles, books, specification sheets, publications, documents, etc., the entire contents of which are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions, and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be considered to be consistent with the teachings of the present disclosure as an example, not as a limitation. Correspondingly, the embodiments of the present disclosure are not limited to the embodiments expressly presented and described herein.

What is claimed is:

1. A sculpting and shaping tool for dental resin, comprising: a handle, a rotating assembly, and a sculpting and shaping tip, wherein one end of the sculpting and shaping tip is coaxially and rotatably connected to one end of the handle through the rotating assembly.

2. The sculpting and shaping tool of claim 1, wherein the sculpting and shaping tip is in a shape of a cone, and a bottom surface of the cone is opposite to the handle.

3. The sculpting and shaping tool of claim 2, wherein a length of the cone is in a range of 3 mm to 10 mm, and a diameter of the bottom surface of the cone is in a range of 1 mm to 2 mm.

4. The sculpting and shaping tool of claim 1, wherein the sculpting and shaping tip is in a shape of a cylinder.

5. The sculpting and shaping tool of claim 4, wherein a length of the cylinder is in a range of 3 mm to 10 mm, and a diameter of the cylinder is in a range of 1 mm to 2 mm.

6. The sculpting and shaping tool of claim 1, wherein the sculpting and shaping tip is in a shape of a semi-ellipsoid, and a bottom surface of the semi-ellipsoid is opposite to the handle.

7. The sculpting and shaping tool of claim 6, wherein a length of a minor axis of the semi-ellipsoid is in a range of 0.5 mm to 2 mm, and a length of a major axis of the semi-ellipsoid is in a range of 2 mm to 5 mm.

8. The sculpting and shaping tool of claim 1, wherein the rotating assembly includes a rotating shaft, a plurality of rollers, and a rotating shaft sleeve; the plurality of rollers are coaxially sleeved onto the rotating shaft; a rotating shaft extension hole is arranged on an end surface of one end of the rotating shaft sleeve; the rotating shaft is coaxially arranged in the rotating shaft sleeve, one end of the rotating shaft extends through the rotating shaft extension hole on the rotating shaft sleeve and is fixedly connected to the one end of the sculpting and shaping tip; and another end of the rotating shaft sleeve is fixedly connected to the one end of the handle.

9. The sculpting and shaping tool of claim 8, wherein the plurality of rollers include at least two rollers.

10. The sculpting and shaping tool of claim 8, wherein the plurality of rollers are arranged in the rotating shaft sleeve, and a diameter of each of the plurality of rollers matches an inner diameter of the rotating shaft sleeve.

11. The sculpting and shaping tool of claim 8, wherein another end of the rotating shaft sleeve is provided with an internal thread, the one end of the handle is provided with an external thread, and the another end of the rotating shaft sleeve is threadedly connected to the one end of the handle.

12. The sculpting and shaping tool of claim 1, wherein the one end of the handle is arranged perpendicular to another end of the handle.

13. The sculpting and shaping tool of claim 1, wherein a cutter tip is disposed on another end of the handle.

14. The sculpting and shaping tool of claim 10, further comprising cap covers, wherein the two cap covers are detachably arranged at two ends of the handle, respectively.
